(19) United States
(12) Patent Application Publication
(10) Pub. No.: US 2005/0231088 A1
(43) Pub. Date: Oct. 20, 2005

(54) Mesh structure of tetraode field-emission display and method of fabricating the same

(76) Inventors: Kuo-Rong Chen, Taoyuan County (TW); Te-Fong Chan, Taoyuen County (TW); Kuei-Wen Cheng, Taoyuan County (TW)

Correspondence Address: Yi-Wen Tseng, 4331 Stevens Battle Lane, Fairfax, VA, 22033, US

(21) Appl. No.: 10/823,751

(22) Filed: Apr. 14, 2004

(51) Int. Cl. H01J 21/10; H01J 1/46; H01J 9/00

(52) U.S. Cl. 313/303; 313/293; 313/495; 445/24; 445/46

(57) ABSTRACT

A mesh structure of tetraode field-emission display and a method of fabricating the same are disclosed. The mesh has a gate layer, an insulation layer and a converging electrode layer. The converging electrode layer is fabricated from a metal conductive plate adhered to one side of a glass plate, and a conductive layer is formed on the other side of the glass plate. The glass plate serves as the insulation layer, and the conductive layer serves as the gate layer. The converging electrode layer, the insulation layer and the gate layer are perforated with at least one aperture to establish a path of electron beam between an anode and a cathode of the tetraode field-emission display.

### BACKGROUND OF THE INVENTION

The present invention relates in general to a field-emission display, and more particular, to a mesh structure of the tetraode field-emission display and a method of fabricating the same.

The field-emission display is a very newly developed technology among flat panel display field. Being self-illuminant, such type of display does not require a back light source like the liquid crystal display. In addition to the better brightness, the viewing angle is broader, power consumption is lower, response speed is faster (no residual image), and the operation temperature range is larger. The image quality of the field-emission display is similar to that of the conventional cathode ray tube (CRT) display, while the dimension of the field-emission display is much thinner and lighter compared to the cathode ray tube display. Therefore, it is foreseeable that the field-emission display may replace the liquid crystal display in the market. Further, the fast growing nanotechnology enables nano-material to be applied in the field-emission display, such that the technology of field-emission display will be commercially available.

FIG. 1 shows a conventional triode field-emission display, which includes an anode plate 10 and a cathode plate 20. A spacer 14 is placed in the vacuum region between the anode plate 10 and the cathode plate 20 to provide isolation and support thereof. The anode plate 10 includes an anode substrate 11, an anode conductive layer 12 and a phosphor layer 13. The cathode plate 20 includes a cathode substrate 21, a cathode conductive layer 22, an electron emission layer 23, a dielectric layer 24 and a gate layer 25. A potential difference is provided to the gate layer 25 to induce electron beam emission from the electron emission layer 23. The high voltage provided by the anode conductive layer 12 accelerates the electron beam with sufficient momentum to impinge the phosphors layer 13 of the anode plate 10, which is then excited to emit a light. To allow electron moving in the field-emission display, the vacuum is maintained at least under 10⁻⁵ torr, such that a proper mean free path of the electron is obtained. In addition, contamination and poison of the electron emission source and the phosphors layer have to be avoided. Further, the electron emission layer 23 and the phosphors layer 13 have to be spaced from each other by a predetermined distance for accelerating the electron with the energy required to generate light from the phosphors layer 13.

The electron beam emitted by the conventional structure is typically in a fan configuration, and the diverging range of such electron beam is difficult to control by the triode field-emission display. The electron beam is easily excessively divergent and may even impinge the phosphors layer 33 of the neighboring unit to degrade the display effect. Therefore, a tetra-polar structure is proposed as shown in FIG. 2. In the tetra-polar structure, a fourth electrode, that is, the converging electrode is formed in addition to the triode structure. A mesh 5 is formed between the cathode plate 40 and the anode plate 30. The mesh 5 includes a converging electrode layer 51, an insulation layer 52 and a gate layer 53. The converging electrode layer 51 is proximal to the anode plate 30, the gate layer 53 is proximal to the cathode plate 40, and the insulation layer 52 is sandwiched between the converging electrode layer 51 and the gate layer 53. An isolation wall 44 is formed to extend between the gate layer 53 and the cathode layer 40. The cathode plate 40 includes a cathode substrate 41, a cathode conductive layer 42 and an electron emission source layer 43. The gate layer 53 and the converging electrode layer 51 carries adequate potentials. A plurality of apertures 54 is formed to extend through the mesh 5. Each of the apertures 54 is aligned with a corresponding unit of anode and cathode, such that electron beam generated from the electron emission source layer 43 can propagate towards the phosphor layer 33. The structure of the mesh 5 is illustrated in FIG. 3. As shown, a metal conductive plate is used as a base of the mesh 5. That is, the converging electrode layer 51 fabricated from the metal conductive plate. The insulation layer 52 is formed on the bottom surface of the metal conductive layer. A conductive layer is then formed on the bottom surface of the insulation layer 52 to serve as the gate layer 53. The metal conductive plate is processed to form an array of through apertures 54. The position of each aperture 54 is aligned with each unit of anode and cathode formed on the anode and cathode plates 30 and 40, respectively. The apertures 54 serve as emission channel for the electron beam emitted from each cathode. The periphery of the metal conductive plate is an inoperative region 55. A plurality of markings 551 can be formed on the inoperative region 55 to aid in alignment of the apertures 54 and the units of anodes and cathodes.

The above tetra-polar structure provides the converging electrode layer 51 to converge the electron beam, such that the electron beam can impinge the corresponding phosphors layer 33 precisely. Therefore, the electron beam is prevented from impinging the phosphor layer 33 of the neighboring units. The display effect of the field emission display is thus greatly enhanced. However, as the insulation layer 52 and the gate layer 53 of the mesh 5 are still fabricated by photolithography process, the process is complicated and the cost is high.

### BRIEF SUMMARY OF THE INVENTION

The present invention provides a mesh structure of a tetraode field-emission display and a method of fabricating the same. In this invention, the mesh structure is fabricated by a process much simpler than the photolithography process, such that the cost is reduced.

The mesh structure provided by the present invention is fabricated by processing a metal conductive layer, forming glass layer on one surface of the metal conductive layer to serve as an insulation layer, and forming a conductive layer on one exposed surface of the glass layer to serve as a gate layer. Thereby, a tri-layer mesh structure is formed.

### BRIEF DESCRIPTION OF THE DRAWINGS

These as well as other features of the present invention will become more apparent upon reference to the drawings therein:

FIG. 1 illustrates a local cross sectional view of a conventional triode field-emission display;

FIG. 2 is a local cross sectional view of a tetra-polar field-emission display;

FIG. 3 is a schematic drawing of a mesh of a tetra-polar field-emission display;

FIG. 4 shows an exploded view of a mesh structure in a first embodiment of the present invention;

FIG. 5 is a perspective view of the mesh structure as shown in FIG. 4;

FIG. 6 is a perspective view of a mesh structure in a second embodiment of the present invention;

FIG. 7 is a perspective view of a mesh structure in a third embodiment of the present invention; and

FIG. 8 shows a local cross sectional view of the mesh structure in FIG. 7 after the gate layer is formed.

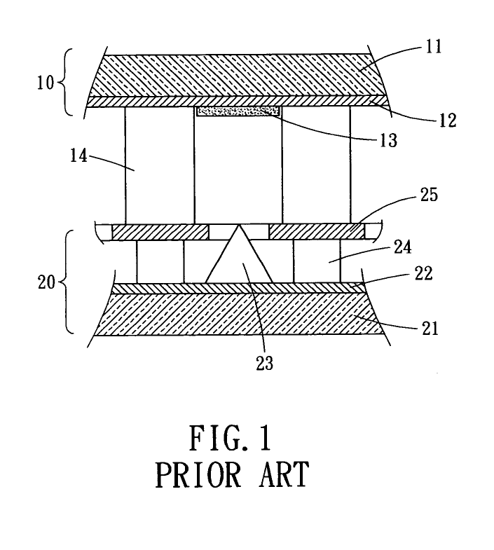

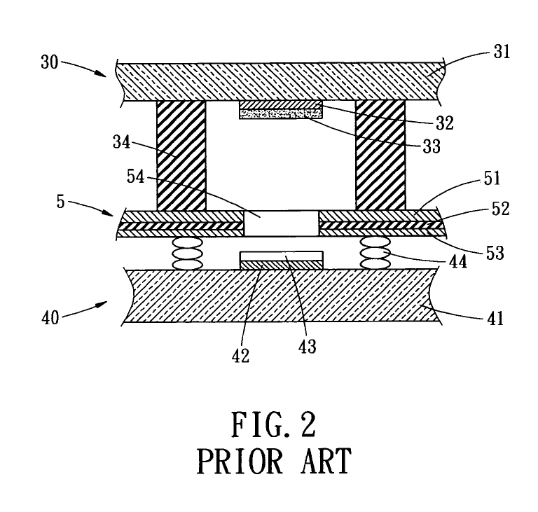

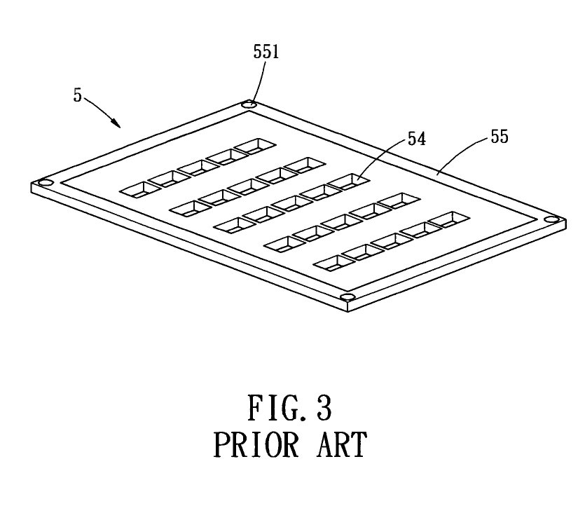

### DETAILED DESCRIPTION OF THE INVENTION

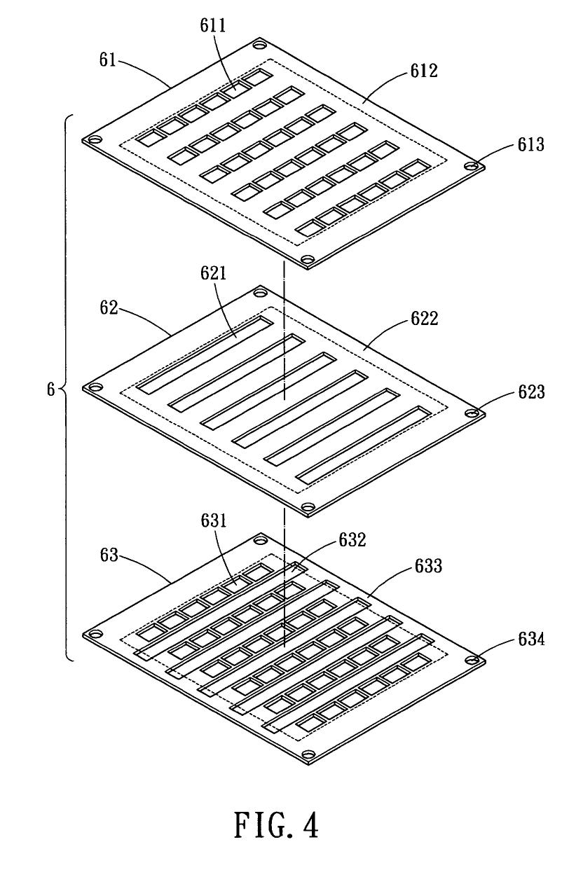

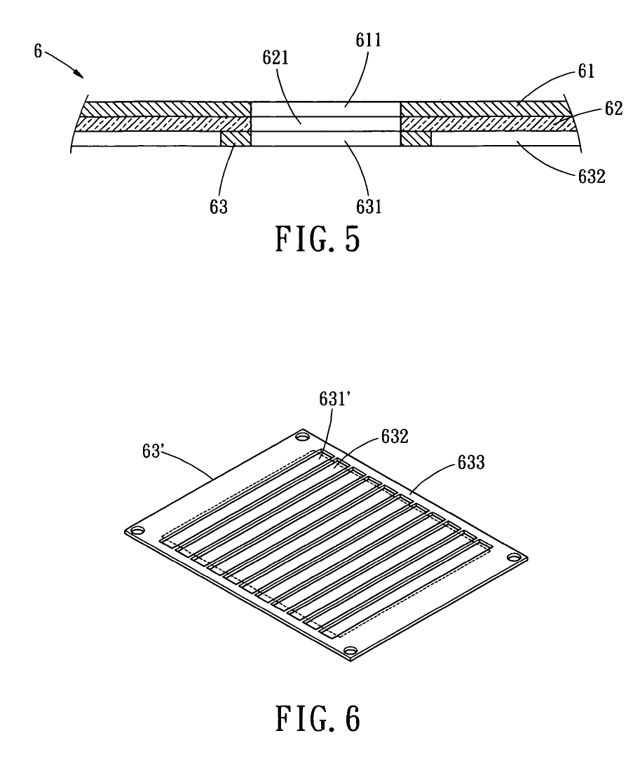

Referring to FIG. 4, an exploded view of a mesh 6 is illustrated. As shown, the mesh is a tri-layer structure constructed by a first conductive layer 61, a glass plate 62 and a second conductive layer 63. Preferably, the first and second conductive layers 61 and 63 are fabricated from the same metal or conductive material. The first and second conductive layers 61 and 63 serve as a converging electrode layer and a gate layer, respectively. A plurality of apertures 611 is formed to extend through the first conductive plate 61. In this embodiment, the apertures 611 are arranged in a rectangular array. Each of the apertures 611 is to be aligned with a corresponding unit of anode and cathode. The periphery of the first conductive layer 61, that is, the region outside of the dash line as shown in FIG. 4, is an inoperative region 612 to be cut away after the package of the field emission display is complete. The glass plate 62 serves as an insulation layer to avoid conduction between the first and the second conductive layers 61 and 63. Similar to the first conductive layer 61, a plurality of holes 621 is formed to extend through the glass plate 62. The holes 621 are aligned with the apertures 611. Preferably, one hole 621 is formed in correspondence with each aperture 611. Alternatively, the holes 621 may be formed with a larger dimension such that one hole 621 covers the range of more than one apertures 611. For example, as shown in FIG. 4, a plurality of elongate holes 621 is formed in the glass plate 62, such that each elongate holes 621 covers the range of a row or a column of the apertures 611. Similar to the first conductive layer 61, a periphery of the glass plate 62 is the inoperative region 622 to be removed after package. A plurality of markings 623 is formed on the inoperative region 622 to aid in alignment. The second conductive layer 63 serves as the gate layer. A plurality of apertures 631 is formed to extend through the second conductive layer 63. Preferably, one aperture 631 is formed aligned with each aperture 611. Or alternatively as shown in FIG. 6, a plurality of elongate slits 631′ and a plurality of isolation slits 632 are alternately formed to extend through the second conductive layer 63′. Each of the elongate slits 631′ is aligned with a row or a column of the apertures 611. The isolation slits 632 extend across the conductive plate 63′ into the inoperative region 633. Therefore, after the inoperative region 633 is removed, two conductive strips are formed at two elongate sides of each elongate slit 631′. Each pair of the conductive strips constructs an independent conductive path. When any pair of conductive strips is biased with a potential, a gate operative to drain the electron from the cathode unit between the pair of conductive strips is formed. The second conductive layer 63 also includes a peripheral inoperative region 633 and a plurality of alignment markings 634 is formed thereon. These three layers are then packaged to form an independent mesh 6. FIG. 5 shows the cross sectional view of the mesh. As shown, the first apertures 611, 621 and 631 are aligned with each other to establish a path of electron beam between an anode and a cathode.

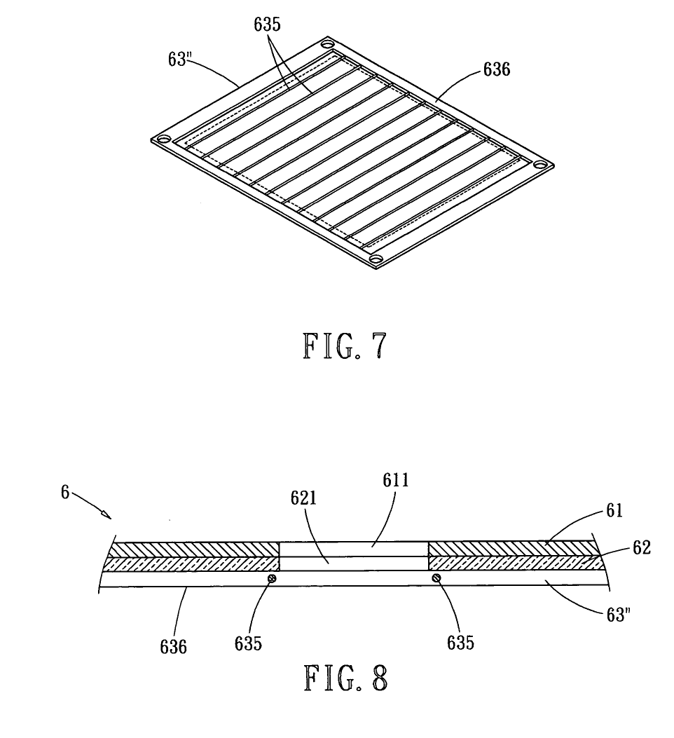

FIG. 7 shows another embodiment of the second conductive layer 63″. As shown, a plurality of parallel conductive lines 635 is formed to extend within a hollow frame 636. The conductive lines 635 are positioned under the first conductive layer 61 between two neighboring rows of the apertures 611. After the inoperative region outside of the dash line is removed, the frame 636 is separate from the conductive lines 635 to form a structure which includes a plurality pair of the conductive lines 635, and each pair of conductive lines 635 sandwiches a row of the first apertures 611, which is equivalent to a row of cathode units as shown in FIG. 8. That is, each pair of the conductive lines 635 serves as a gate.

The fabrication method of the above mesh structure includes selecting the conductive layers 61 and 63 and the glass plate 62 having a thermal coefficient similar to that of the anode plate and the cathode plate to prevent from breakage during high-temperature sintering process for package. An UV glue and a glass glue are applied to the inoperative regions 612, 622 and 632. The three layers (first and second conductive layers 61 and 63 and the glass plate 62) are then stacked with each other by aligning the alignment markings 613, 623 and 633. An ultra-violet light is radiating upon the UV glue for temporally fitting. The temporally fitted mesh 6 is then held by a high-temperature clip and placed into a high-temperature furnace to perform sintering. The UV glue is then vaporized and exhausted due to high temperature. The glass glue then provides permanent fitting of the mesh. Therefore, the screen printing or photolithography process is not required for fabricating the mesh, the process is simplified, and the cost is reduced.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. A mesh structure disposed between a plurality of anode units and cathode units of a tetraode field emission display, comprising:
a first conductive layer to serve as a converging electrode layer having a proximal surface facing the anode units and a distal surface opposing to the proximal surface, the first conductive plate comprising a plurality of first apertures extending therethrough;
a glass plate formed on the distal surface of the first conductive layer to serve as an insulation layer, the glass plate including a plurality of second apertures extending therethrough; and
a second conductive layer formed on the glass plate to serve as a gate electrode layer, the second conductive layer having a proximal surface facing the cathode units and a distal surface opposing to the proximal surface, wherein the second conductive layer includes a plurality of third apertures extending therethrough and aligned with the first and second apertures.

2. The mesh structure of claim 1, wherein each second aperture is aligned with one corresponding first aperture.

3. The mesh structure of claim 1, wherein each second aperture covers an opening range of a plurality of the first apertures.

4. The mesh structure of claim 1, wherein each third aperture is aligned with one corresponding first aperture.

5. The mesh structure of claim 1, wherein each third aperture covers an opening range of a plurality of the first apertures.

6. A mesh structure of a tetra-polar field-emission display, comprising:
a converging electrode layer having an array of first apertures extending therethrough;
an insulation layer having one side adjacent to the converging electrode layer, the insulation layer having a plurality of second apertures aligned with the first apertures; and
a gate layer including a plurality of conductive lines formed on the insulation layer at one side opposite to the side adjacent to the converging electrode layer, wherein each of the conductive lines is aligned with a portion of the converging electrode layer between one pair of neighboring rows of the first apertures.

7. The mesh structure of claim 6, wherein the gate layer further comprises a hollow frame within which the conductive lines extend.

8. The mesh structure of claim 6, wherein each of the second apertures is aligned with one corresponding first aperture.

9. The mesh structure of claim 6, wherein each of the second apertures is aligned with a plurality of corresponding first apertures.

10. A method of fabricating a mesh structure mounted between an anode plate and a cathode plate of a tetra-polar field-emission display, comprising:
providing a first conductive plate;
forming a plurality of first apertures extending through the first conductive plate;
providing a glass plate;
forming a plurality of second apertures extending through the glass plate;
temporally attaching one side of the glass plate to the first conductive plate with the second apertures aligned with the first apertures;
providing a second conductive plate;
forming a plurality of third apertures extending through the second conductive plate;
temporally attaching the second conductive plate to the glass plate with the third apertures aligned with the first and second apertures; and
permanently stacking the first conductive plate, the glass plate and the second conductive plate to form the mesh structure.

11. The method of claim 10, wherein the step of temporally attaching the glass plate to the first conductive plate includes applying an ultra-violet glue therebetween.

12. The method of claim 10, wherein the step of temporally attaching the second conductive plate to the glass plate includes applying an ultra-violet glue therebetween.

13. The method of claim 10, wherein the step of permanently stacking the first and second conductive layers and the glass plate includes a high-temperature sintering process.

14. The method of claim 10, further comprising selecting the first and second conductive layer fabricated from a material having a thermal expansion coefficient similar to that of the anode plate and the cathode plate.

15. The method of claim 10, further comprising selecting the glass plate having a thermal expansion coefficient similar to that of the anode plate and the cathode plate.
